(19) United States
(12) Patent Application Publication
(10) Pub. No.: US 2009/0222838 A1
(43) Pub. Date: Sep. 3, 2009

(54) TECHNIQUES FOR DYNAMIC CONTACT INFORMATION

(75) Inventor: Junius Ho, San Francisco, CA (US)

Correspondence Address: KACVINSKY LLC;4500 BROOKTREE ROAD, SUITE 102, WEXFORD, PA, 15090, US

(73) Assignee: PALM, INC., SUNNYVALE, CA (US)

(21) Appl. No.: 12/040,814

(22) Filed: Feb. 29, 2008

(51) Int. Cl. G06F 9/54

(52) U.S. Cl. 719/314

(57) ABSTRACT

Techniques involving contact information are disclosed. For example, an apparatus may include a contact entry generation module and an entry updating module. The contact entry generation module creates a contact entry having a location-specific information field. The entry updating module obtains an update for the location-specific information field from a remote device. This update corresponds to a current location.

### BACKGROUND

Mobile computing devices, such as smart phones, may provide various processing capabilities. For example, mobile devices may provide personal digital assistant (PDA) features, including word processing, spreadsheets, and synchronization of information with a desktop computer. In addition, such devices may have wireless communications capabilities to provide features, such as mobile telephony, mobile e-mail access, web browsing, reception of content (e.g., video and audio), and so forth.

Moreover, such devices may maintain contact-related information. For example, personal information management applications may allow users to store and access information for individuals, businesses, schools, and other entities. This information may include physical addresses, telephone numbers, e-mail addresses, as well as other forms of information. Devices typically maintain contact-related information in a static manner. In other words, the contact-related information does not typically change unless it is manually updated by a device user.

Some contacts may involve entities having multiple locations. Examples of such entities include restaurant chains, coffeehouse chains, hotel chains, and banks having multiple branches. Also, some types of entities may exist at multiple locations. Such multiple locations may be either affiliated or unaffiliated. For example, multiple public library branches may be associated with the same library system or with different library systems.

Often, a user may travel with his device and desire locally-relevant contact information at multiple locations. For instance, at each of the multiple locations, the user may want information for the nearest coffeehouse of a particular chain. However, due to the typically static nature of stored contact information, the user's device may have information for a coffeehouse at a location that is different from the present location (e.g., a location close to the user's home or office). In this situation, the user may have to manually search for information regarding the nearest coffeehouse.

Thus, as a user travels with his device, it may be desirable to receive update information for certain contacts.

### BRIEF DESCRIPTION OF THE DRAWINGS

FIG. 1 illustrates an exemplary apparatus.

FIGS. 2A and 2B are diagrams of exemplary operational scenarios.

FIG. 3 illustrates an embodiment of a logic flow.

FIGS. 4A and 4B are diagrams of exemplary contact entries.

FIG. 5 is a view of an exemplary handheld device.

### DETAILED DESCRIPTION

Various embodiments may be generally directed to techniques involving contact information. For instance, an apparatus may include a contact entry generation module and an entry updating module. The contact entry generation module creates a contact entry having a location-specific information field. The entry updating module obtains an update for the location-specific information field from a remote device. This update corresponds to a current location. Embodiments, however, are not limited to this exemplary apparatus.

Embodiments may include one or more elements. An element may comprise any structure arranged to perform certain operations. Each element may be implemented as hardware, software, or any combination thereof, as desired for a given set of design parameters or performance constraints. Although embodiments may be described with particular elements in certain arrangements by way of example, embodiments may include other combinations of elements in alternate arrangements.

It is worthy to note that any reference to “one embodiment” or “an embodiment” means that a particular feature, structure, or characteristic described in connection with the embodiment is included in at least one embodiment. The appearances of the phrases “in one embodiment” and “in an embodiment” in various places in the specification are not necessarily all referring to the same embodiment.

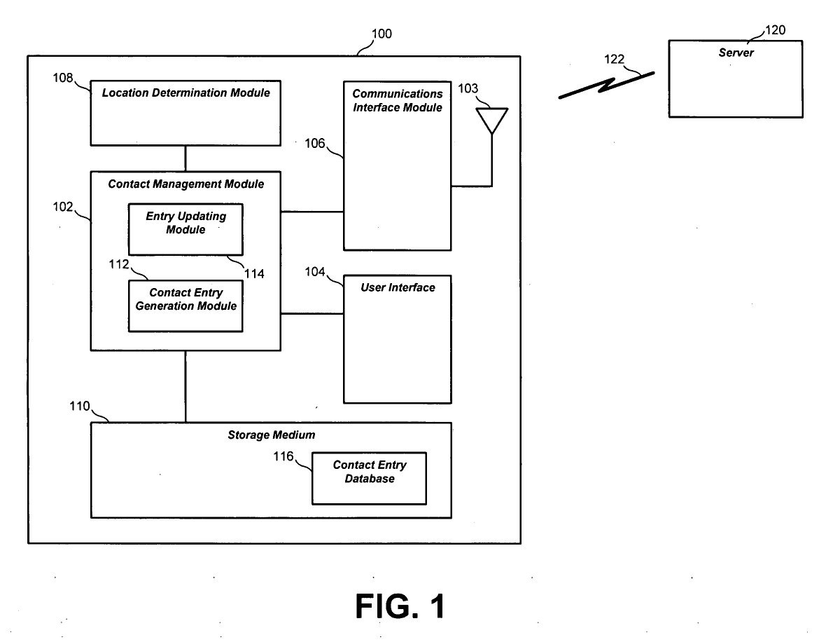

FIG. 1 illustrates an exemplary apparatus 100 that may obtain information regarding events. FIG. 1 shows that apparatus 100 may comprise various elements. For instance, FIG. 1 shows that apparatus 100 may include a contact management module 102, a user interface 104, a communications interface module 106, a location determination module 108, and a storage medium 110. These elements may be implemented in hardware, software, firmware, or any combination thereof.

Contact management module 102 may perform operations involving the storage and maintenance of contact information. For instance, contact management module 102 may provide for the generation of contact entries. A contact entry includes fields that provide information regarding an individual, organization, or other entity. For example, a contact entry may include a physical address (e.g., a street address) field, a telephone number field, a fax number field, an e-mail address field, and/or a descriptive data field. However, contact entries are not limited to these exemplary fields.

One or more fields within a contact entry may be designated as being location-specific. Accordingly, a contact entry containing such location-specific field(s) may be associated with an entity having multiple locations. As indicated above, examples of such entities include restaurant chains, coffeehouse chains, hotel chains, banks having multiple branches, and so forth.

Alternatively, a contact entry containing such location-specific field(s) may pertain to an entity of a type that may exist at multiple locations. Instances of such entity types may be either affiliated or unaffiliated. A public library branch is an example of such an entity. For example, affiliated library branches may be associated with a particular library system, while unaffiliated library branches are associated with different library systems. Embodiments, however, are not limited to these examples.

In embodiments, contact entries pertaining entity types may be based on referring sources. For example, entity types may be based on social networking sources. As an example, a website, server, or information resource could maintain location-specific lists of entities that people in a defined social network (e.g., acquaintances and/or friends) have visited.

Accordingly, entity types, such as friends' recommended restaurants could be employed. Thus, when people in a social network visit such entities, they could provide ratings to the website, server, or information resource. In turn, upon an updating condition, a user's contact entry would be updated based on the ratings provided by people in the user's social network. Embodiments, however, are not limited to these examples.

A contact entry having location-specific field(s) may include a field containing an updating resource indicator. This indicator identifies a resource (such as a server) that may provide information for the location-specific field(s). This resource indicator may be in the form of a uniform resource locator (URL). However, resource indicators of other forms or types may be alternatively or additionally employed. For instance, indicators or addresses associated with short messaging service (SMS), multimedia messaging service (MMS), e-mail, instant messaging (IM), and so forth may be employed. Thus, information for location specific fields may be delivered (e.g., automatically delivered) according to various techniques, such as hypertext (e.g., HTTP) downloads, SMS messages, MMS messages, instant messages, and so forth.

Further, in embodiments, location-specific field(s) may have corresponding updating preferences. For example, an entry for a particular entity type may be updated according to preferences, such as the closest, the most popular, and/or other criteria. For instance, a contact entry for an entity type “pizzeria” may be updated to provide the closest pizzeria, or the best pizzeria (e.g., best consumer rating or expert review) within a particular distance range (e.g., a 30-mile radius).

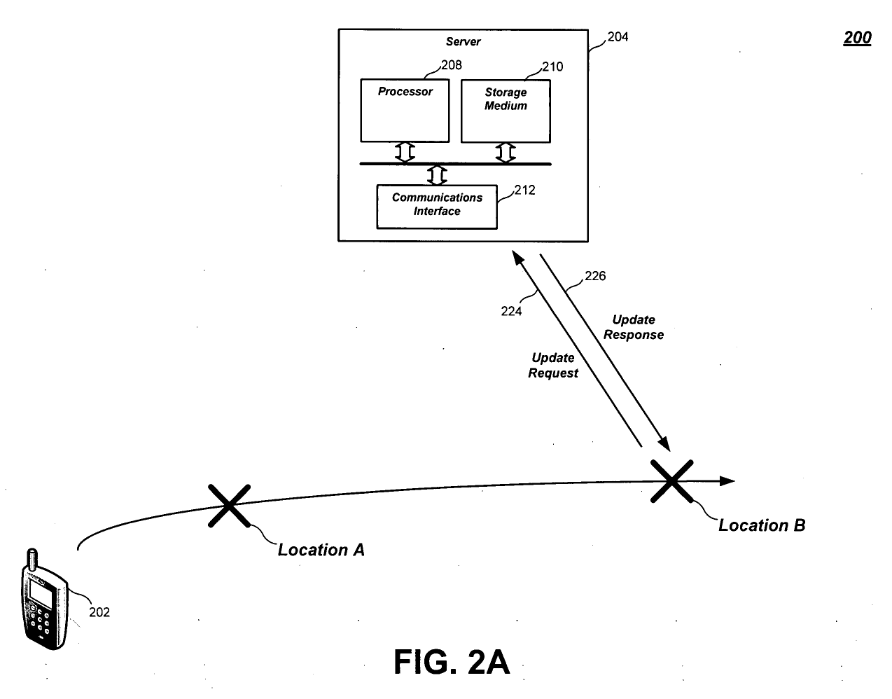

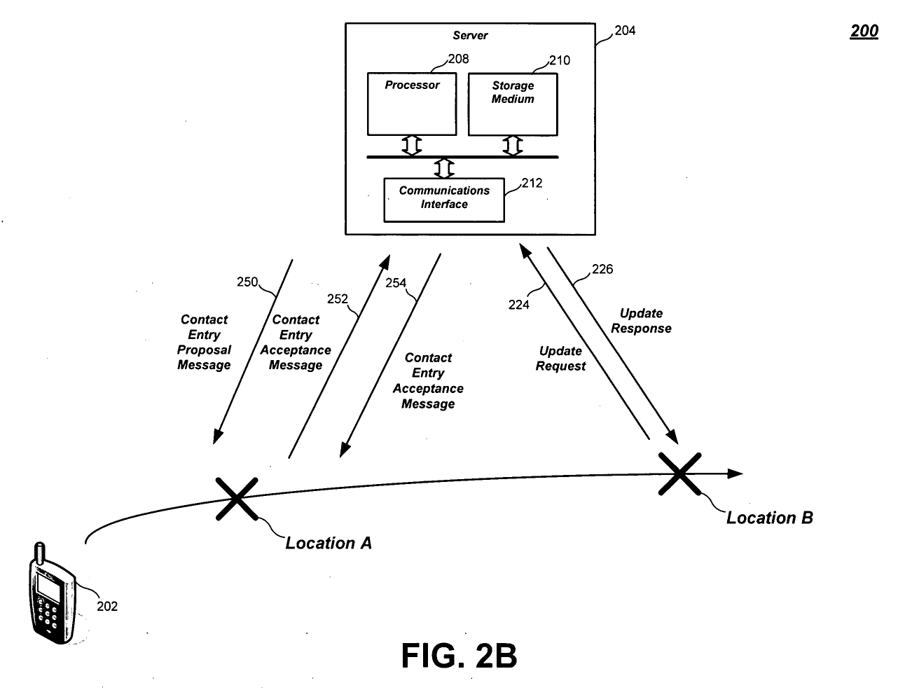

Such updating preferences may be user-selectable. For example, certain predetermined preferences may be available. Further, for remotely-originated contact entries (such as described below with reference to FIG. 2B) such preferences may be selected from one or more choices (e.g., through a menu).

As shown in FIG. 1, contact management module 102 may include a contact entry generation module 112 and an entry updating module 114. Contact entry generation module 112 generates contact entries. Such generation may be initiated by a user of apparatus 100. More particularly, a user may perform operations that create a contact entry. These operations may include the user commencing a contact entry generation process, the user entering data associated with the contact entry, and the user saving the generated contact entry. Such operations may involve the user interacting with user interface 104.

Additionally or alternatively, the generation of contact entries may be initiated through messages originated by remote devices. For instance, apparatus 100 may receive a proposed contact entry message. Upon receipt, the user (through user interface 104) may view the proposed contact entry and determine whether to store it.

Entry updating module 114 receives updated information for location-specific fields within contact entries. Such information may be received (via communications interface module 106) from updating resources identified by such contact entries. This updated information may be received in various ways. For example, entry updating module 114 may generate request messages that request information location-specific fields. Such requests may be directed to updating resources specified by the corresponding contact entries. In response, entry updating module 114 may receive response messages from such resources that provide the requested information.

Location determination module 108 may determine a current location of apparatus 100. Based on such determinations, entry updating module 114 may decide whether to update location-specific fields within contact entries.

The current location of apparatus 100 may be determined in various ways. For instance, location determination module 108 may include a global positioning system (GPS) receiver that receives timing signals from (GPS) satellites. From such timing signals, location determination module 108 may determine the current location of apparatus 100 through trilateration computational techniques.

Alternatively or additionally, location determination module 108 may employ techniques other than GPS to determine the location of apparatus 100. Such techniques may include cellular triangulation, wireless local area network hotspot connectivity, the reception of location information from wireless network operators (via communications interface module 106), the input of location data from a user (e.g., through user interface 104), as well as other techniques. The current location may be computed as latitude, longitude, and altitude coordinates. However, other forms may be employed.

As shown in FIG. 1, communications interface module 106 is coupled to contact management module 102. Communications interface module 106 provides for the exchange of information with other devices. Such information may include, for example, the aforementioned request and response messages handled by entry updating module 114. Also, such information may include messages providing proposed contact entries received from remote devices. As described above, proposed contact entries may be handled by contact entry generation module 112. These messages are provided as examples and not as limitations. Therefore, embodiments may exchange other information.

For purposes of illustration, FIG. 1 shows communications interface module 106 (through an antenna 103) exchanging information with a server 120. FIG. 1 further shows that this exchange occurs across a link 122 of a wireless network.

Exemplary wireless networks include wireless local area networks (WLANs), such as IEEE 802.11 WiFi links, as well as wireless metropolitan area networks (WMANs), such as IEEE 802.16 WiMax links and IEEE 802.16e WiBro links. Also, wireless networks may include personal area networks (PAN) such as Bluetooth. Further, wireless networks may include radio frequency identification (RFID) links. Moreover, such wireless networks may include cellular and satellite communications systems. However, other types of wireless networks may be employed.

Also, communications interface module 106 may (additionally or alternatively) communicate with devices across wired networks. Exemplary wired networks include, for example, local area networks (LANs), such as IEEE 802.3 Ethernet networks, and/or wired telephony networks. The embodiments, however, are not limited to these examples.

To provide such features, communications interface module 106 may include electronics, such as modulators, demodulators, amplifiers, filters, and/or antennas. Furthermore, communications interface module 106 may include components and/or functionality to operate according to one or more protocol layers. Such protocol layers may provide features, such as packet encapsulation/decapsulation, error correction encoding/decoding, signaling, link protocols, and/or media access protocols. Embodiments, however, may include other components and/or functionality. These features may be implemented in hardware, software, firmware, or any combination thereof.

User interface 104 facilitates user interaction. This interaction may involve the input of information from a user and/or the output of information to a user. For example, as described herein, user interface 104 may provide for the generation of contact entries, the viewing of contact entry information, and so forth. Accordingly, user interface 104 may include one or more devices, such as a keyboard (e.g., a full QWERTY keyboard), a keypad, a display (e.g., a touch screen), a microphone, and/or an audio speaker. The embodiments, however, are not limited to these examples.

Storage medium 110 may be implemented using any machine-readable or computer-readable media capable of storing data, including both volatile and non-volatile memory. For example, such storage media may include read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information.

It is worthy to note that some portion or all of storage medium 110 may be included in other elements of apparatus 100. For instance, some or all of storage medium 110 may be included on a same integrated circuit or chip with elements of apparatus 100. Alternatively, some portion or all of storage medium 110 may be disposed on an integrated circuit or other medium (e.g., a hard disk drive) that is external. The embodiments are not limited in this context.

As described above, contact entries may be saved upon their generation. These saved event objects may be stored in a contact entry database 116. FIG. 1 shows that contact entry database 116 may be included in storage medium 110. Contact entry database 116 may be implemented in various ways (e.g., as a relational database, as an object oriented database, with various data structures/objects, etc.).

In addition to providing contact entry database 116, storage medium 110 may store information such as application documents, e-mails, media items (e.g., image files, audio files, video files, etc.), and so forth. Such information (as well as the information within contact entry database 116) may be stored in various encoded or unencoded formats.

Although FIG. 1 shows contact entries being stored locally (e.g. within storage medium 110), embodiments may store contact entries remotely. For instance, contact entries may be uploaded (via communications interface module 106) and stored by a remote device. Thus, contact entry database 116 may be implemented locally and/or remotely.

In general operation, apparatus 100 may create and update contact entries. For instance, contact entry generation module 112 may create contact entries that are stored in contact entry database 116. As described herein, such contact entries may have one or more location-specific fields.

Such location-specific fields may be updated by entry updating module 114. As described above, this may involve entry updating module 114 (via communications interface module 106) sending request messages to an identified resource. Additionally or alternatively, this may involve entry updating module 114 (via communications interface module 106) uploading event objects to remote entities (e.g., servers) for remote monitoring. Embodiments, however, are not limited to this context.

As described above, the elements of FIG. 1 may be implemented in hardware, software, firmware, or any combination thereof. Thus, implementations may include one or more processors that execute instructions or control logic stored in a storage medium (e.g., memory) such as storage medium 110. The embodiments, however, are not limited to such implementations.

FIG. 2A is a diagram of an exemplary operational scenario 200. In this scenario, a device 202 processes a contact entry as it moves between locations. In particular, device 202 is shown moving from a first location (“Location A”) to a second location (“Location B”). Device 202 may be implemented in various ways. For example, device 202 may include the features described above with reference to FIG. 1.

At Location A, device 202 creates and stores a contact entry. This contact entry is for a nearby coffeehouse that is part of a coffeehouse chain. The created contact entry includes one or more fields. For example, the contact entry may include a location-specific field that provides the coffeehouse's address. In addition, the contact entry includes a field indicating a resource to provide updates for the address field. This resource may be provided by a server 204, which device 202 may access through one or more communications networks.

After the contact entry is created, device 202 may seek to update it upon the occurrence of one or more updating conditions. Examples of updating condition(s) include the passage of a predetermined time interval (e.g., since the contact entry's creation or previous updating), and/or a location change for device 202 that is greater than a predetermined threshold (e.g., greater than a particular distance). The embodiments, however, are not limited to these examples.

For instance, at Location B, device 202 determines that an updating condition has occurred. Therefore, device 202 seeks to update the location-specific field of the created contact entry. As shown in FIG. 2A, device 202 sends an update request message 224 to server 204. This request message may include various forms of information. For example, update request message 224 may include the current location (e.g., GPS coordinates) of device 202. In addition, update request message 224 may include an identifier of the location-specific field. Additionally or alternatively, update request message 224 may include one or more fields of the corresponding contact entry. Embodiments, however, are not limited to these examples.

Server 204 receives and processes update request message 224. In response, server 204 sends an update response message 226 to device 202. This response message may include a value for the location-specific field of the contact entry that corresponds to the current location provided in update request message 224. Upon receipt of update response message 226, device 202 updates the contact entry. As described above, such updating may be in accordance with preference(s) (e.g., closest, highest-rated etc.)

FIG. 2A shows that resource server 204 may include a processor 208, a storage medium 210, and a communications interface 212. Processor 208 may include one or more processing elements (e.g., one or more microprocessors). Thus, processor 208 may execute control logic or instructions (e.g., software) that may provide functionality for the features of server 204. Such control logic or instructions may be stored in storage medium 210.

In addition, storage medium 210 may store data, such as location-specific fields for contact items. These fields may be arranged according to locations. However, embodiments are not limited to such data and/or arrangements of data. Storage medium 210 may be implemented using any machine-readable or computer-readable media capable of storing data, including both volatile and non-volatile memory. Examples of such media are provided above with reference to FIG. 1.

Communications interface 212 may provide for the exchange of information with other devices, as described herein. Accordingly, these communications interfaces may each include components to communicate across various network(s), such as the wired or wireless networks described above with reference to FIG. 1. To provide such features, communications interface 212 may include electronics, such as modulators, demodulators, amplifiers, filters, and/or antennas. Moreover, communications interface 212 may include components and/or functionality to operate according to one or more protocol layers. Such protocol layers may provide features, such as packet encapsulation/decapsulation, error correction encoding/decoding, signaling, link protocols, and/or media access protocols. Embodiments, however, may include other components and/or functionality. These features may be implemented in hardware, software, firmware, or any combination thereof.

FIG. 2B is a diagram of an operational scenario 250. This scenario is similar to the scenario of FIG. 2A. However, the scenario of FIG. 2B includes the remotely-initiated generation of a contact entry.

For instance, at Location A, device 202 receives a contact entry proposal message 250 from server 204. This message proposes that device 202 create a contact entry for a particular entity (e.g., a business, organization, person, etc.). Upon receipt of message 250, the user of device 202 is prompted (e.g., through user interface 104) to accept or decline this proposal.

If accepted, device 202 generates and sends a contact entry acceptance message 252 to server 204. Based on this message, server 204 sends a contact entry message 254 to device 202. This message includes a contact entry that may include location-specific field(s). Upon receipt of message 254, device 202 may store it (e.g., in contact entry database 116).

Accordingly, in FIG. 2B (as in FIG. 2A) device 202 determines that an updating condition has occurred. Thus, at this point an update is requested and received, as described above.

In embodiments, contact entry proposals (such as contact entry proposal message 250) may be received through users signing-up or registering for such services (e.g., through a website, an SMS or MMS message, an e-mail, etc.). Such services may be based on particular locations. For example, a user may elect to receive such proposals for a particular city.

As an example, a user traveling to a new city on vacation may accept an SMS request for the top steakhouses in the area. The user then has a contact entry created for “Steak”. This contact entry may have location-specific fields that can be updated. As described above, such updating may be in accordance with preference(s) (e.g., closest, highest-rated etc.)

The messages exchanged in FIGS. 2A and 2B may be in various formats. Examples include (but are not limited to) HTTP messages, HTTPS messages, SMS messages, MMS messages, e-mail messages, and IM messages.

Also, the scenarios of FIGS. 2A and 2B depict interactions with a single remote device (i.e., server 204). However, such scenarios may include interactions with multiple remote devices (server and/or non-server devices).

Embodiments may be further described with reference to the following figures and accompanying examples. Some of the figures may include a logic flow. Although such figures presented herein may include a particular logic flow, it can be appreciated that the logic flow merely provides an example of how the general functionality as described herein can be implemented. Further, the given logic flow does not necessarily have to be executed in the order presented, unless otherwise indicated. In addition, the given logic flow may be implemented by a hardware element, a software element executed by a processor, or any combination thereof. The embodiments are not limited in this context.

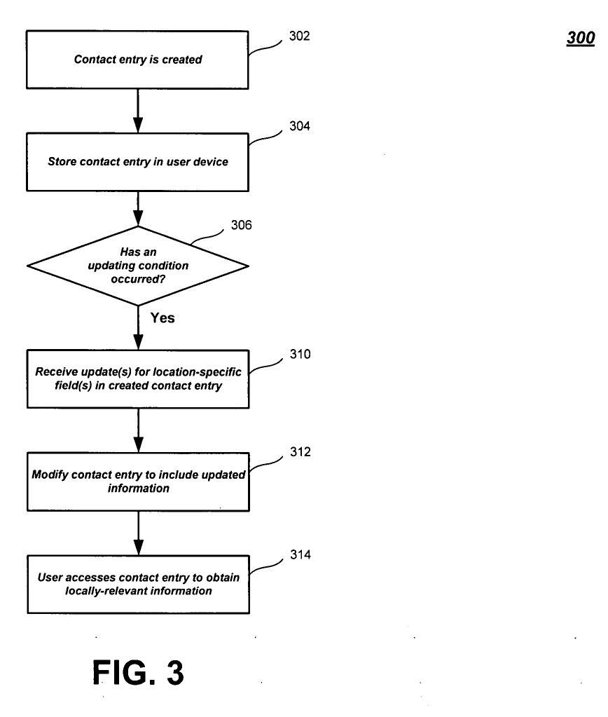

FIG. 3 illustrates one embodiment of a logic flow. In particular, FIG. 3 illustrates a logic flow 300, which may be representative of the operations executed by one or more embodiments described herein. Although FIG. 3 shows a particular sequence, other sequences may be employed. Also, the depicted operations may be performed in various parallel and/or sequential combinations.

As shown in FIG. 3, logic flow 300 includes a block 302, in which a contact entry is created at a user device. This user device may include apparatus 100 of FIG. 1. Thus, block 302 may be performed by contact entry generation module 112. The embodiments, however, are not limited to the examples of FIG. 1.

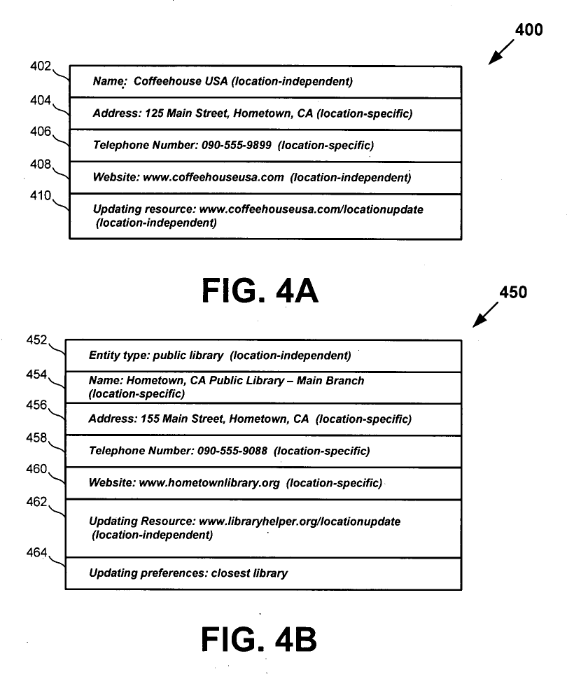

The created contact entry may include various forms of information. For instance, the created contact entry may include one or more location-specific fields. The contact entry may also include one or more updating resource indicators. As described above, such indicator(s) identify a resource (such as a server) that may provide information for the location-specific field(s). The created contact entry may be implemented in the manner described below with reference to FIGS. 4A and 4B. However, other implementations may be employed.

In embodiments, creation of the contact entry may be initiated by a user (e.g., through user interface 104). Alternatively, creation of the contact entry may be initiated through the reception of a proposed contact entry from a remote device. Thus, creation of the contact entry at the user device may occur upon the user accepting the proposed contact entry (e.g., through interaction with a user interface).

At a block 304, the contact entry may be stored by the user device. For example, the contact entry may be stored in contact entry database 116 of FIG. 1. However, embodiments, may store the contact entry in other entities (e.g., local and/or remote entities).

At a block 306, the user device determines whether one or more updating conditions have occurred. If so, then operation proceeds to a block 310. Examples of updating conditions are provided below.

At block 310, the device receives updates for the location-specific field(s) in the created contact entry. This may involve, for example, sending a request message to the updating resource included in the created contact entry, and receiving a corresponding response from the updating resource. This response may contain updated information for the location-specific fields.

At a block 312, the stored contact entry is modified to contain the updated information. For example, in the context of FIG. 1, this may involve storing the updated information in contact entry database 116. Thus, at a block 314, the user may access the contact entry to obtain locally-relevant information.

As described above, location-specific field(s) of the contact entry created at block 302 may be updated upon the occurrence of one or more updating conditions. Various updating condition(s) may be employed. For instance, an updating condition may occur when a change in the user device's location is greater than a predetermined threshold (e.g., greater than a predetermined distance). Alternatively or additionally, an updating condition may occur when the time period since the occurrence of the most recent updating condition exceeds a predetermined time threshold.

Also, an updating condition may occur based on a current time, such as the current day of the week (e.g., whether it is a weekday or a weekend day). Further, an updating condition may occur based on user initiation. For instance, when a user desires to update location-specific field(s), he may enter an input that triggers an updating condition. Also, updating conditions may occur based on other events and/or received notifications. The updating conditions provided above are provided as examples and not as limitations. Accordingly, other updating conditions may be employed.

FIGS. 4A and 4B are diagrams showing formats of exemplary contact entries that may include various data fields. For instance, FIG. 4A shows contact entry 400 for a coffeehouse that is part of a multiple locations coffeehouse chain.

Contact entry 400 includes multiple fields 402-410. Each of these fields may be labeled as location-specific or location-independent. However, embodiments may include further labels. As shown in FIG. 4A, fields 402, 408, and 410 are labeled location-independent, while fields 404 and 406 are labeled location-specific.

Field 402 provides a contact name. This name is shown as “Coffeehouse USA”. An address (a location) for the contact is provided by field 404. As shown in FIG. 4A, this address is “125 Main Street, Hometown, Calif.”. Also, field 406 provides a telephone number for this location (“090-555-9899”). In addition, field 408 provides a website for the coffee house chain (“www.coffeehouseusa.com”).

Field 410 indicates an updating resource (e.g., a server) that may provide information updates for location-specific fields (i.e., fields 404 and 406). As described above, this resource indicator may be in the form of a uniform resource locator (URL) (e.g., “www.coffeehouseusa.com/locationupdate”). However, other forms or types of resource indicators may be employed.

FIG. 4B is a diagram of a further contact entry 450 that pertains to a particular entity type. Contact entry 450 includes location independent fields 452, 462, and 464. In addition, contact entry 450 includes location-specific fields 454 through 460.

Location-independent field 452 indicates an entity type for contact entry 450. As shown in FIG. 4B, this entity type is “public library”. Further, location-independent field 462 indicates an updating resource (“www.libraryhelper.com/locationupdate”), which may be used to obtain updates for the location-specific fields of contact entry 450. Also, location-independent field 464 indicates updating preferences. Such preferences indicate criteria (e.g., the closest, the most popular, etc.) for providing updates for the contact entry. As described above,

Regarding the location-specific fields, field 454 specifies a contact name (“Hometown, Calif. Public Library—Main Branch”), field 456 specifies a contact address (or location) (“155 Main Street, Hometown, Calif.”), field 458 specifies a contact telephone number (“090-555-9088”), and field 460 specifies a website (“www.hometownlibrary.org”).

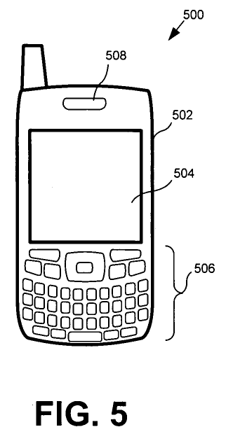

FIG. 5 provides a view of an exemplary handheld device 500, which may include apparatus 100 of FIG. 1. In particular, FIG. 5 is a front view that shows device 500 having a case 502. Further, this view shows device 500 having a display (e.g., a touch screen) 504, a keypad 506 (including, for example, a QWERTY keyboard, navigation buttons, and so forth), and a speaker 508. With reference to FIG. 1, these components may be included in user interface 104. The view of FIG. 5 is provided for the purposes of illustration, and not limitation. Thus, embodiments may include further devices, handheld or otherwise.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. An apparatus, comprising:
a contact entry generation module to create a contact entry, the contact entry comprising a location-specific information field; and
an entry updating module to obtain an update for the location-specific information field from a remote device;
wherein the update to the location-specific information field corresponds to a current location.

2. The apparatus of claim 1, wherein the entry updating module is to obtain the update to the location-specific information field upon the occurrence of an updating condition.

3. The apparatus of claim 2, wherein the updating condition includes a location change greater than a predetermined threshold.

4. The apparatus of claim 2, wherein the updating condition includes a passage of a predetermined time interval since creation of the contact entry.

5. The apparatus of claim 2, wherein the updating condition includes a passage of a predetermined time interval since receiving a previous update of the location-specific information field.

6. The apparatus of claim 2, wherein the entry updating module is to generate a request message upon the occurrence of the updating condition, and wherein the update to the location-specific information field is received in response to the request message.

7. The apparatus of claim 6, further comprising a communications interface module;
wherein the communications interface module is to send the request message across one or more communications networks and receive an update message in response to the request message; and
wherein the update message includes the update to the location-specific information field is received in response to the request message.

8. The apparatus of claim 6, wherein the request message includes the current location.

9. The apparatus of claim 6, wherein the request message includes an identifier of the location-specific field.

10. The apparatus of claim 1, wherein the contact entry further comprises an indicator of a remote resource to provide the update for the location-specific information field.

11. The apparatus of claim 1, further comprising a storage medium to store the contact entry.

12. The apparatus of claim 1, further comprising a location determination module to determine the current location.

13. A method, comprising:
creating a contact entry, the contact entry comprising a location-specific information field; and
obtaining an update for the location-specific field when an updating condition has occurred, the update from a remote device;
wherein the update to the location-specific information field corresponds to a current location.

14. The method of claim 13, wherein the updating condition includes a location change greater than a predetermined threshold.

15. The method of claim 13, wherein the updating condition includes a passage of a predetermined time interval since creation of the contact entry.

16. The method of claim 13, wherein the updating condition includes a passage of a predetermined time interval since receiving a previous update of the location-specific information field.

17. The method of claim 13, further comprising:
storing the contact entry in a storage medium.

18. The method of claim 13, further comprising determining the current location.

19. A system, comprising:
a server; and
a device having a contact entry generation and an entry updating module;
wherein the contact entry generation module is to create a contact entry, the contact entry comprising a location-specific information field;
wherein the entry updating module is to obtain an update to the location-specific information field upon an occurrence of an updating condition, the update from a remote device; and
wherein the update to the location-specific information field corresponds to a current location.
an event management module and a communications interface module;
wherein the event management module is to create an event object corresponding to an event, the event object comprising a desired status information indicator; and
wherein the communications interface module is to receive desired status information from the server, the desired status information based on the desired status information indicator.

20. An article comprising a computer-readable storage medium containing instructions that if executed enable a system to:
create a contact entry, the contact entry comprising a location-specific information field; and
obtain an update for the location-specific field when an updating condition has occurred, the update from a remote device;
wherein the update to the location-specific information field corresponds to a current location.
